(19) United States
(12) Patent Application Publication
(10) Pub. No.: US 2003/0131520 A1
(43) Pub. Date: Jul. 17, 2003

(54) Bite indicator

(76) Inventor: Fred Bagshaw, Dundas (CA)

Correspondence Address: Ingrid E. Schmidt, 560-120 King Street West, Hamilton, ON, L8P 4V2, CA

(21) Appl. No.: 10/046,610

(22) Filed: Jan. 16, 2002

(51) Int. Cl. A01K 85/01; A01K 97/12

(52) U.S. Cl. 43/17

(57) ABSTRACT

The invention provides a bite indicator for use with a fishing pole. The bite indicator includes a housing and a flexible, partially translucent tube. The housing is adapted to receive a light source for emitting a focused beam of light. The tube includes means for internal light reflection so that when the tube flexes relative to the focused beam of light, the means for internal light reflection are positioned in a path of light from the light source, thereby showing a change in the position of the tube indicative of a bite.

### FIELD OF THE INVENTION

This invention relates to a bite indicator for use with a fishing pole which provides an indication of a fish's bite contemporaneously with a change in the position of a distal end of the fishing pole.

### BACKGROUND OF THE INVENTION

It is customary for sport fishermen to position a fishing pole at the edge of a body of water and to wait for a fish to bite while the fisherman is sitting some distance away from the fishing pole. For instance, the fisherman may wish to talk with other fishermen, but prefer not to have such conversations at the water's edge because the sounds of the fishermen's voices would disturb the fish.

When a fish bites on a hook, a distal end of the fishing pole is moved downwardly, because the fish pulls on a fishing line to which the hook is attached. The fisherman wishes to be alerted to a fish's bite as soon as possible because once alerted, the fisherman can take certain actions with the fishing pole directed to catching the fish. Because prompt action on the part of the fisherman is more likely to result in the fish being caught, it is important that the fisherman be notified promptly of a bite. A fish may initially nibble on bait on a hook, resulting in relatively small tugs on a fishing line, and also resulting in corresponding relatively small repeated downward movements of the distal end of the fishing pole. Therefore, the fisherman wishes to be alerted to even relatively small movements of the distal end of the fishing pole.

The problem arises that, at night, a fisherman who is positioned a distance away from the fishing pole cannot easily see movement of the distal end of the fishing pole which is indicative of a bite. In particular, relatively small movements of the distal end, indicative of a fish nibbling and possibly becoming hooked, are difficult for the fisherman to see.

Use of a “glow-stick”, attached in the vicinity of the distal end of a fishing pole for indicating that a fish is biting, is known. The glow-stick is a relatively thin plastic tube, closed at each end, which holds materials which are luminescent while the materials react with each other, in a chemical reaction. Once the reaction has been completed, the glow-stick is no longer luminescent, and must be replaced. Glow-sticks have a relatively short useful life, and the use of glow-sticks is relatively expensive.

Glow-sticks also may not alert the fisherman to relatively small movements of the distal end of the fishing pole. In these circumstances, the fisherman would only be alerted if the fisherman happened to be closely watching the glow-stick when the relatively small movements are taking place.

There is therefore a need for a bite indicator for use with a fishing pole which provides an indication of a fish's bite contemporaneously with a change in the position of a distal end of the fishing pole.

### SUMMARY OF THE INVENTION

In abroad aspect of the present invention, there is provided a bite indicator for use with a fishing pole comprising a housing adapted to receive a light source for emitting a focused beam of light and a flexible, partially translucent tube. The tube includes means for internal light reflection so that when the tube flexes relative to the focused beam of light, the means for internal light reflection are positioned in a path of light from the light source, thereby showing a change in the position of the tube indicative of a bite.

### BRIEF DESCRIPTION OF THE DRAWINGS

The invention will be better understood with reference to the drawings, in which:

FIG. 1 is an isometric view of a fishing pole with a preferred embodiment of the bite indicator attached thereto;

FIG. 2 is an isometric view of a portion of the fishing pole and bite indicator of FIG. 1, showing the bite indicator, drawn at a larger scale;

FIG. 3 is a cross-section side view of the bite indicator of FIG. 1, showing the bite indicator attached to the fishing pole while the fishing pole is in a rest position, drawn at a larger scale;

FIG. 4 is a cross-section side view of the bite indicator of FIG. 1 attached to the fishing pole, showing the fishing pole in a bent position, indicative of a bite;

FIG. 5 is an exploded view of the bite indicator, drawn at a larger scale;

FIG. 6 is a cross-section side view of an alternative embodiment of the bite indicator attached to the fishing pole, with the fishing pole in the rest position, drawn at a larger scale; and

FIG. 7 is a cross-section side view of the bite indicator of FIG. 6, with the fishing pole in a bent position, indicative of a bite.

### DETAILED DESCRIPTION OF THE INVENTION

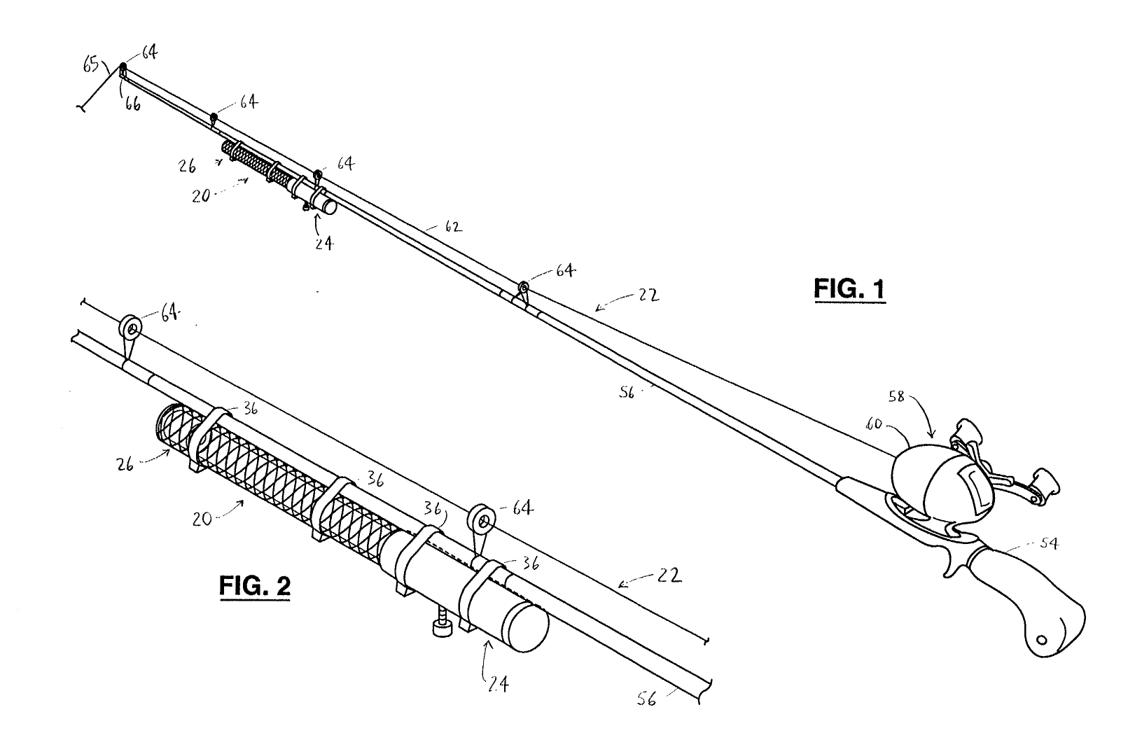

Reference is first made to FIGS. 1 and 2 to describe a preferred embodiment of a bite indicator indicated generally by the numeral 20 in accordance with the invention. The bite indicator 20 is for use with a fishing pole 22, and has a housing 24 and a flexible, partially translucent tube 26. The housing 24 comprises any suitable material, preferably a lightweight plastic material such as polyvinylchloride (PVC).

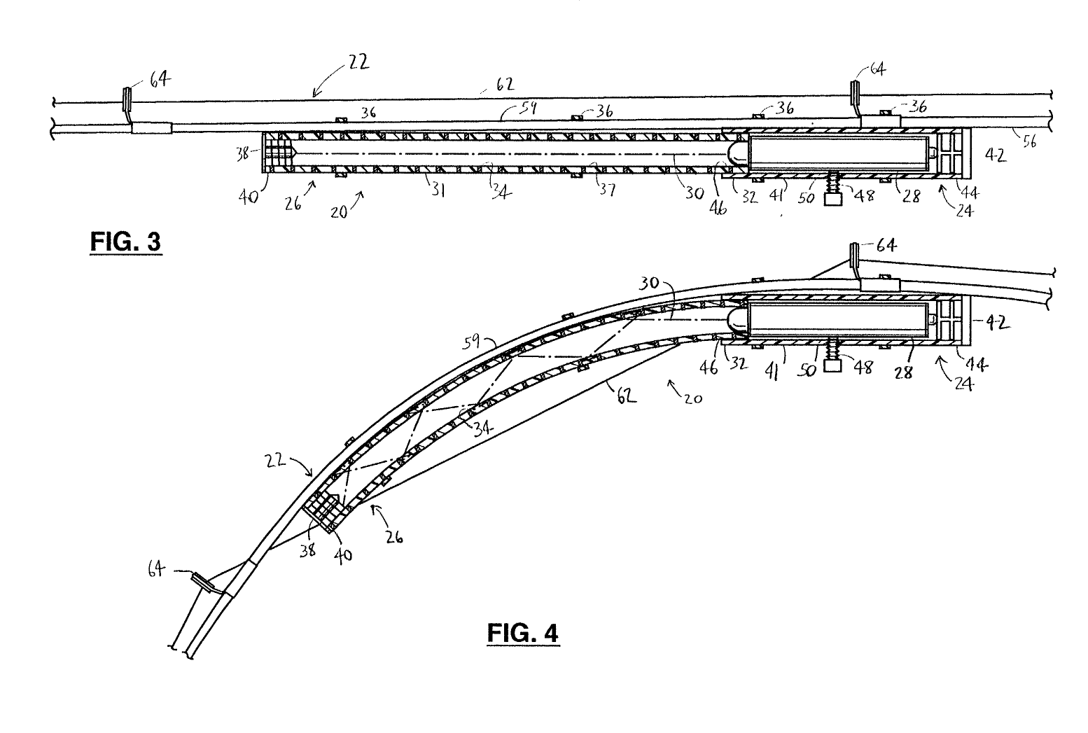

As can be seen in FIGS. 3 and 4, a light source 28 is receivable in the housing 24. The light source 28 can be a source of any suitable light, such as laser light, or incandescent light in the form of a focused beam of light 30. The light source 28 is preferably powered by one or more batteries included therein.

The tube 26 includes a wall element 31 which is flexible and partially translucent. Preferably, the wall element 31 is attached to the housing 24 at a distal end 32 of the housing 24, as will be discussed in more detail. The tube 26 includes means for internal light reflection. In the preferred embodiment shown in FIGS. 1-5, the means for internal light reflection are in the form of web elements 34 which are included in the wall element 31. Except for the web elements 34, the wall element 31 comprises any suitable translucent material. Translucent plastic tubing has been found to be suitable material for the wall element 31. It is preferable that the wall element 31 is PVC braided hose, which also integrally includes the web elements 34. Preferably, the PVC braided hose is approximately ⅛ inch in diameter. Other arrangements of including, incorporating, or attaching the means for internal reflection to the wall element 31 are possible.

As can be seen in FIGS. 3 and 4, the bite indicator 20 is preferably attached to the fishing pole 22 along the length of the bite indicator 20 by a plurality of fasteners 36. Any suitable fastener may be used. While various other arrangements could be employed, in the construction shown in FIGS. 1-4 and 6-7, the fasteners 36 are plastic tie-down connectors which are adjustable to fasten the bite indicator securely to the fishing pole 22.

The fishing pole 22 and the bite indicator 20 attached to the fishing pole 22 are shown in a rest position in FIG. 3. In FIG. 4, however, the fishing pole 22 and the bite indicator 20 are shown in a bent position, indicative of a bite. It will be appreciated that the fishing pole 22 and the bite indicator 20 are capable of assuming a range of bent positions. As can be seen in FIG. 3, when the tube 26 is in the rest position, the focused beam of light 30 is not directed to an internal surface 37 of the wall element 31. FIG. 4 shows that, when the fishing pole 22 and the bite indicator 20 are in a bent position, the means for internal light reflection—i.e., the web elements 34—are positioned in a path of light from the light source 28. The focused beam of light 30 reflects off the web elements 34 when the fishing pole 22 and the bite indicator 20 are in the bent position, thereby showing a change in the position of the tube 26 indicative of a bite.

The components of the preferred embodiments of the tube 26 and the housing 24 will now be described in more detail. As can be seen in FIGS. 3, 4 and 5, a plug 38 is inserted into a distal end 40 of the wall element 31. Preferably, the plug 38 is coloured red or any other suitable darker tone or colour which would reflect only a relatively small portion of light striking the plug 38 when the tube 26 is in the rest position.

As can be seen in FIGS. 1-5, in the preferred embodiment, the housing 24 includes a body 41 which is generally in the shape of a cylinder. The housing 24 also includes a cap 42 which is receivable in a proximal end 44 of the body 41. While various other arrangements could be employed, in the construction shown in FIGS. 3-5, the light source 28 is located and held in the housing 24 between a proximal end 46 of the wall element 31 and the cap 42. In the preferred embodiment, the proximal end 46 of the wall element 31 is attached to the distal end 32 of the housing 24 in any suitable manner. Preferably, the cap 42 is received in the proximal end 44 of the housing 24 in a friction fit, so that the cap 42 can relatively easily be removed from the proximal end 44 by a fisherman (not shown), but remain positioned in the proximal end 44 when the bite indicator 20 is in use.

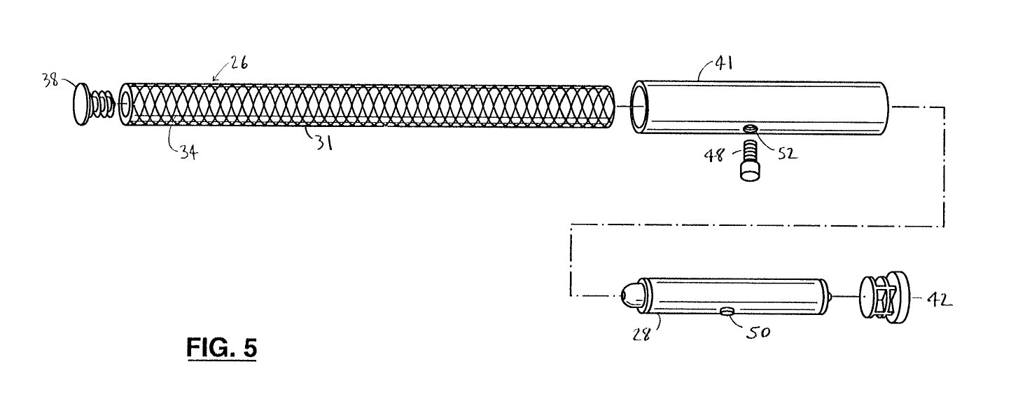

The components of the preferred embodiment of the housing 24 are shown in FIG. 5. Preferably, the housing 24 also includes a switch device in the form of a screw 48 which is adapted for cooperation with a switch 50 included in the light source 28. Various forms of switch devices could be employed, depending in part on the form of switch 50 included in the light source 28. In the preferred embodiment, the light source 28 is activated, and emits the focused beam of light 30, when the switch button 50 is in a depressed position. When the switch button 50 is not in the depressed position, the light source 28 is not activated. As shown in FIGS. 3-5, the screw 48 is received in a threaded aperture 52 in the body 41 so that the screw 48, when moved inwardly relative to the body 41 to an activated position, presses upon the switch button 50, and holds the switch button 50 in the depressed position. The light source 28 continues to emit a focused beam of light 30 as long as the screw 48 is in the activated position, and also for as long as the light source's batteries can provide the power required. When the light source 28 is to be turned off, the screw 48 is turned in the aperture 52 so that the screw 48 is retracted from contact with the switch button 50, the screw 48 moving outwardly relative to the body 41 to a de-activated position.

As can best be seen in FIGS. 1 and 2, the fishing pole 22 is generally of conventional construction. The fishing pole 22 includes a fishing pole handle 54, a flexible rod portion 56 extending from the fishing pole handle 54, and a reel device 58. The bite indicator 20 is attached to the rod portion 56 along an intermediate part 59. The reel device 58 includes a reel 60, a fishing line 62, and a hook (not shown), of conventional construction. The fishing line 62 extends from the reel through a plurality of eyelets or guides 64 positioned at intervals along the flexible rod portion 56, and substantially aligned with each other, to the hook. When a fish (not shown) bites or nibbles on the hook, a part 65 of the fishing line 62 which extends beyond a distal end 66 of the rod portion 56 is pulled downward. As can be seen in FIG. 1, the rod portion 56 typically tapers gradually from a larger diameter in the vicinity of the handle 54 to a relatively smaller diameter in the vicinity of the distal end 66. The downward pull on the part 65 of the fishing line 62 causes the distal end 66 of the rod portion 56 to move downward, and the pulled fishing line 62 thereby causes the intermediate part 59 of the rod portion 56 to move from the rest position (as shown in FIGS. 1-3) to a bent position (as shown in FIG. 4).

In some jurisdictions, positioning a light of any sort at the distal end 66 of the rod portion 56 might be prohibited by applicable regulations. Because of these regulations, it is preferred that the intermediate part 59 (along which the bite indicator 20 is attached) is remote from the distal end 66. Preferably, the intermediate part 59 is also remote from the handle 54.

In use, the preferred embodiment of the bite indicator 20 is fastened to the fishing pole 22 by the fasteners 36. The cap 42 is removed from the body 41 to enable the light source 28 to be received in the body 41. After the light source 28 is received in the body 41, the light source 28 is activated by the fisherman moving the screw 48 to the activated position. When a fish bites or nibbles on the hook, the pull of the fish on the fishing line 62 causes the distal end 66 of the rod portion 56 to move downward, in turn causing the intermediate part 59 of the rod portion 56 to move from the rest position to a bent position, as can be seen in FIG. 4, and as previously described. This movement of the intermediate part 59 in turn causes the wall element 31 to flex relative to the focused beam of light 30, so that the web elements 34 are then positioned in a path of light from the light source 28, to reflect light internally.

It will be understood that FIG. 4 is for illustrative purposes only and shows a simplified path of a focused beam of light 30 which is shown as a very thin beam of light, reflected internally by the web elements 34. The web elements 34 can also be seen in FIG. 5. In practice, the focused beam of light 30 typically is not as focused as shown in FIGS. 3 and 4. For example, in practice, when the intermediate part 59 of the rod portion 56 is in the rest position, as shown in FIG. 3, the focused beam of light 30 illuminates the interior of the wall element 31 generally, at least to a limited extent. When the intermediate part 59 of the rod portion 56 is in a bent position, in practice, the light 30 strikes at least one web element 34 which reflects and propagates the light internally in the tube 26.

With the web elements 34 positioned in a path of light from the light source 28, light from the light source 28 is substantially reflected inside the wall element 31. As a result, the contrast between the appearance of the bite indicator 20 when the wall element 31 is in the rest position and its appearance when the wall element 31 is in a bent position is substantial. The fisherman's attention is drawn to the bite indicator 20 when the wall element 31 is in a bent position because the wall element 31 is then filled with internally reflected light. In comparison, the wall element 31 has only the focused beam of light 30 in it, substantially unreflected, when the wall element 31 is in the rest position.

The rod portion 56 and the wall element 31 are biased to the rest position. In particular, the wall element 31 is preferably as flexible as the rod portion 56. Because of this, the bite indicator 20 provides indications to the fisherman of even relatively small bites, or nibbles. These indications are provided because even a relatively small flexing of the tube 26 relative to the focused beam of light 30 results in internal reflection of the light from the light source 28. A series of nibbles results in light in the wall element 31 appearing to “flicker”, to alert the fisherman.

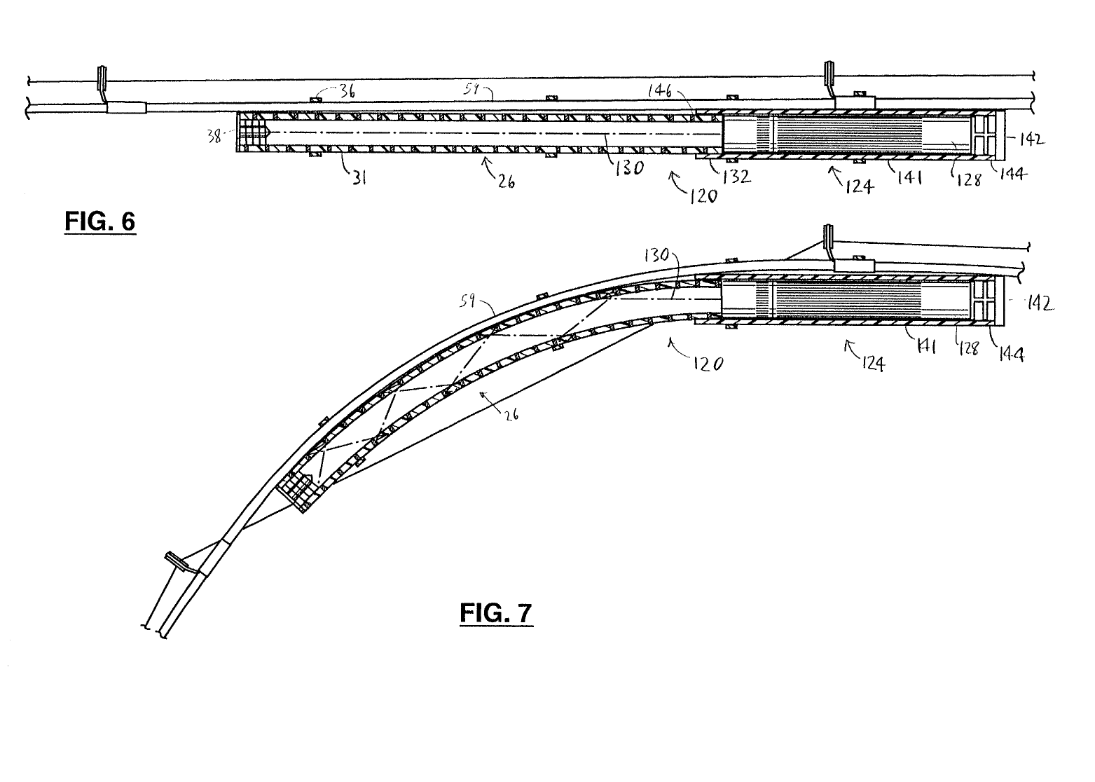

In FIGS. 6 and 7, elements are numbered so as to correspond to like elements shown in FIGS. 1 through 5. An alternative embodiment of the bite indicator 120 is shown in FIGS. 6 and 7. The bite indicator 120 comprises a housing 124 into which a light source 128 is receivable. As shown in FIGS. 6 and 7, the proximal end 46 of the flexible, partially translucent tube 26 is receivable in a distal end 132 of the housing 124. The housing 124 includes a body 141 and a cap 142 receivable in a proximal end 144 of the body 141. As in the preferred embodiment, and as shown in FIGS. 6 and 7, the light source 128 is located and held in the body 141 between the cap 142 and the proximal end 46 of the wall element 31.

The light source 128 is activated by the fisherman before the light source 128 is placed in the housing 124. Preferably, the light source 128 can be turned on or off by turning a first part of the light source relative to a second part of the light source. The light source 128 does not include a switch in the form of a button. Accordingly, the housing 124 does not include a switch device such as the screw 48. Upon activation of the light source 128, the light source 128 produces a focused beam of light 130, and the focused beam of light 130 is reflected by the web elements 34 when the tube 26 is moved to a bent position.

In use, the fisherman removes the cap 142 from the body 141, activates the light source 128, and inserts the light source 128 into the body 141, so that the focused beam of light 130 emitted by the light source 128 is directed at the plug 38 when the tube 26 is in the rest position. The cap 142 is inserted into the proximal end 144 of the body 141 to hold the light source 128 in the body 141. The bite indicator 120 functions in the same way as the preferred embodiment of the bite indicator 20. When the wall element 31 moves to a bent position due to movement of the intermediate part 59 in response to a bite or nibble, the web elements 34 are positioned in a path of light from the light source 128. When the wall element 31 is in the rest position, light from the light source 128 is directed to the plug 38, and the light is not substantially reflected inside the wall element 31.

It will be understood that FIG. 7 is for illustrative purposes only and shows a simplified path of a focused beam of light 130 which is shown as a very thin beam of light. In practice, the focused beam of light 130 typically is not as focused as shown in FIGS. 6 and 7. For example, in practice, when the intermediate part 59 of the rod portion 56 is in the rest position, as shown in FIG. 6, the focused beam of light 130 also illuminates the interior of the wall element 31 generally, at least to a limited extent. When the intermediate part 59 of the rod portion 56 is in a bent position, in practice, the focused beam of light 130 strikes at least one web element 34 which reflects and propagates the light internally in the tube 26.

It will be evident to those skilled in the art that the invention can take many forms, and that such forms are within the scope of the invention as claimed. For example, the bite indicator 20 could have clip-on fasteners having a predetermined diameter to position the bite indicator 20 at the intermediate part 59. Also, clip-on fasteners having a predetermined diameter could conveniently be integrally molded with the bite indicator 20. The spirit and scope of the appended claims should not be limited to the description of the preferred versions contained herein.

I claim:

1. A bite indicator for use with a fishing pole, the bite indicator having:
a housing adapted to receive a light source for emitting a focused beam of light; and
a flexible, partially translucent tube having means for internal light reflection such that when the tube flexes relative to the focused beam of light, said means for internal light reflection are positioned in a path of light from the light source, thereby showing a change in the position of the tube indicative of a bite.

2. A bite indicator according to claim 1 in which a proximal end of the flexible, partially translucent tube is attached to the housing.

3. A bite indicator according to claim 1 in which the housing includes a switch device adapted for cooperation with the light source when the light source is received in the housing, such that the light source can be activated and de-activated by the switch device.

4. A bite indicator according to claim 1 in which the means for internal light reflection comprise a web positioned coaxially to the tube, the web including a plurality of reflective surfaces.

5. A bite indicator according to claim 1 additionally including a light source.

6. A bite indicator according to claim 5 in which the light source is a source of laser light.

7. A bite indicator according to claim 5 in which the light source is a source of incandescent light.

8. A bite indicator according to claim 1 additionally including a plurality of fasteners for attaching the bite indicator to selected portions of the fishing pole.

9. A bite indicator and fishing pole assembly including:
a fishing pole handle;
a flexible rod portion extending from the handle;
a reel device;
a bite indicator fastened to the rod portion distal to the handle, the bite indicator having:
a housing;
a light source received in the housing and adapted for emitting a focused beam of light; and
a flexible, partially translucent tube coupled to the housing, the tube having means for internal light reflection such that when the tube flexes relative to said focused beam of light, said means for internal light reflection are positioned in a path of light from the light source, thereby showing a change in the position of the rod portion indicative of a bite.
